(19) United States
(12) Patent Application Publication
(10) Pub. No.: US 2002/0196482 A1
(43) Pub. Date: Dec. 26, 2002

(54) Dry erase printer presentation board

(76) Inventors: Tim M. Hoberock, Boise, ID (US); David Arellano, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/892,422

(22) Filed: Jun. 26, 2001

(51) Int. Cl. H04N 1/46

(52) U.S. Cl. 358/500

(57) ABSTRACT

The present invention provides a presentation system for printing an electronic image directly to a writing surface. The present invention provides a printer configured to print an image on the writing surface. In one embodiment, the writing surface is made of an impervious or non-absorptive material and the printer is adapted to print with ink that is erased readily by wiping with cloth or paper.

### FIELD OF THE INVENTION

The invention relates generally to presentation systems and more specifically, to a presentation board with an integrated printer.

### BACKGROUND OF THE INVENTION

Various presentation systems are known. In one system, images are drawn on a transparent sheet, which is then projected onto a display area by an overhead projector or display screen. In another system, images are manually drawn on a presentation board, such as a chalkboard, paper, or dry-erase board. In still another system, images are created on a computer and a projection system is used to display the computer images. Alternative presentation systems that allow for the convenient generation of professional-looking modifiable images are desirable.

### SUMMARY OF THE INVENTION

In one embodiment, the present invention provides a presentation system including a writing surface and a printer configured to traverse the writing surface to print an image using dry-erase ink.

The present invention also provides a method for creating an image to be viewed during a presentation, the method including obtaining, in electronic form, an image to be viewed, sending the image to a presentation system including a printer adapted to traverse a presentation board and print thereon, and printing the image on the presentation board.

### BRIEF DESCRIPTION OF THE FIGURES

FIG. 1 is a schematic illustration of a presentation system of the present invention including a printer configured to traverse a writing surface to print an image.

FIG. 2 is a schematic illustration of a presentation system of the present invention including a continuous writing surface adapted to loop around and move beneath a reciprocating printhead of a printer.

FIG. 3 is a schematic illustration of a presentation system of the present invention including a linear writing surface spooled between two rollers.

FIG. 4 is a schematic illustration of a presentation system of FIG. 2 including a scanner, attached conventional printer, and user input devices.

FIG. 5 is a schematic illustration of the presentation system.

### DETAILED DESCRIPTION OF THE INVENTION

The presentation system of the present invention may be used to provide fast and efficient drawing of repeated or frequently used images without the need to hand draw or pre-print the images onto transparencies or paper prior to presentation. For example, borders for a table, company confidential stamps, or design drawings can be printed automatically on the writing surface or presentation board for discussion and/or modification during a presentation.

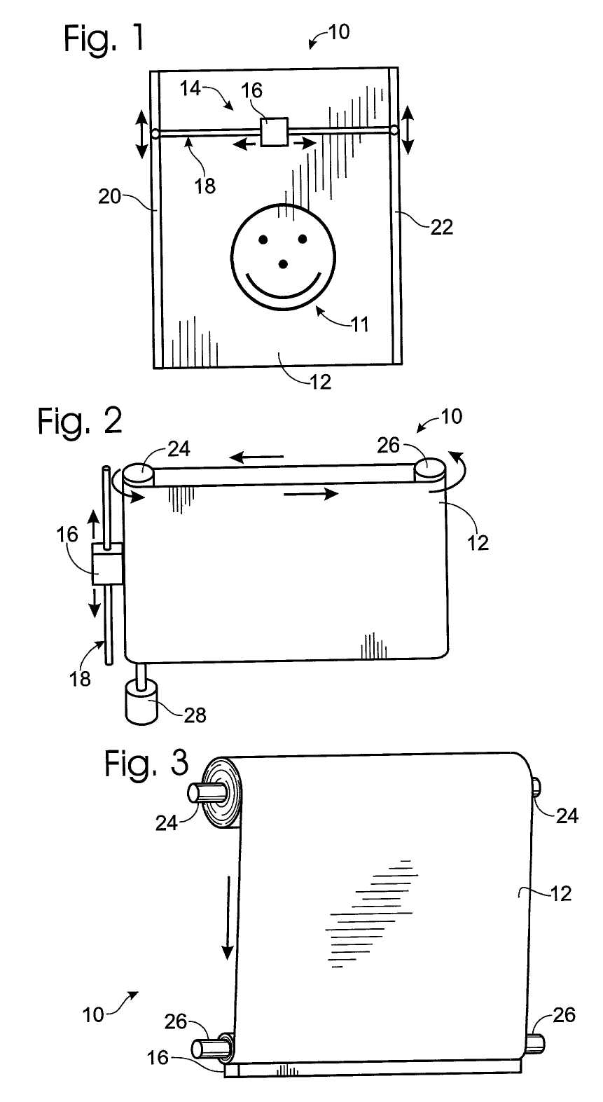

FIG. 1 depicts a presentation system of the present invention. The presentation system is shown generally at 10. System 10 includes a writing surface 12 and a printer 14. The printer includes at least one printhead 16, which is adapted to print an image 11 on writing surface 12. Printhead 16 is any suitable apparatus adapted to deposit ink on writing surface 12 such that an electronic image transmitted to printer 14 is reproduced on the writing surface. In order to facilitate printing onto writing surface 12, either or both of printhead 16 and writing surface 12 may move relative to each other. Any suitable method for moving the printhead across the writing surface may be used.

For example, printhead 16 may reciprocate on a traverse rail 18 in order to facilitate movement of the printhead in the x-direction. A belt-drive, screw-drive, or other suitable mechanism may drive the reciprocating movement of the printhead 16 on the traverse rail 18. The traverse rail may itself run along tracks 20 and 22 to facilitate movement in the y-direction. Any belt-drive, screw-drive, or other suitable mechanism, with or without a motor, may facilitate movement of traverse rail 18 along tracks 20 and 22. As an example, an on-board processor (not shown) having electrical connections to printhead 16, traverse rail 18, and tracks 20 and 22 may control movement of the printhead across the traverse rail and movement of the traverse rail across writing surface 12.

Rather than, or in addition to, having printhead 16 traverse writing surface 12 in both the X and Y directions, as described above, writing surface 12 may be adapted to move past printhead 16 in either the X or Y direction. For example, as shown in FIG. 2, rollers 24 and 26 engage writing surface 12, so that the writing surface may be passed around the roller to effect movement of the writing surface past printhead 16 in the x-direction. One or more of the rollers may be driven by motor 28. Printhead 16 may then reciprocate along traverse rail 18 in the y-direction. In combination, the use of the rolling writing surface and the reciprocating printhead allows the printhead to print on the entire writing surface. As will be understood, writing surface 12 should be flexible so that it can be formed around rollers 24 and 26. The writing surface may be a continuous loop that is reused by the presentation system multiple times. Alternatively, the writing surface may take the form of a single sheet or roll that is spooled onto rollers 24 and 26 and moved past printhead 16, as shown in FIG. 3. As also shown in FIG. 3, printhead 16 may take the form of a full length printhead, spanning the width (or length) of writing surface 12, in which case traverse rail 18 is not required.

As stated above, printhead 16 is any suitable apparatus adapted to deposit ink on writing surface 12. In one embodiment, the printer 14 may include two or more printheads, each capable of printing with a different color ink. The ink may be of any suitable type including traditional printer ink. In one embodiment, the printhead is adapted to deposit erasable ink, such as dry-erase ink on the writing surface. Dry-erase ink is generally described as an ink composition that permits writing on an impervious or non-absorptive surface such as a sheet of synthetic resin, metal, glass and enamel, and is erased readily by wiping with cloth or paper. Examples of dry-erase inks that are suitable for the present invention are disclosed in U.S. Pat. No. 3,157,633 to Kuhn, U.S. Pat. No. 3,449,319 to Kuhn, U.S. Pat. No. 4,091,034 to Kuhn, U.S. Pat. No. 4,102,644 to Hauser et al., U.S. Pat. No. 4,144,028 to Hauser et al., U.S. Pat. No. 4,871,371 to Harris, U.S. Pat. No. 4,877,411 to Hines et al., U.S. Pat. No. 5,043,013 to Kluger et al., U.S. Pat. No. 5,059,244 to King et al., U.S. Pat. No. 5,620,943 to Brendle, and U.S. Pat. No. 6,031,023 to Carroll (each of which is hereby incorporated by reference in its entirety for all purposes).

Writing surface 12 may be of any suitable print media including paper, plastic, fabric or the like. In one embodiment, the writing surface is adapted to receive non-permanent ink, which can easily be erased. For example, the writing surface may be suitable for receiving dry-erase ink. Dry-erase media have been previously described as substitutes for chalkboards. For example, U.S. Pat. No. 3,563,782 to Liberman et al. (hereby incorporated by reference in its entirety for all purposes) teaches such writing surfaces as well as inks for marking upon these surfaces. Dry-erase surfaces may be made, for example, of any impervious or non-absorptive material such as synthetic resin, metal, glass, plastic, enamel, melamine, polypropylene, polyester film such as Mylar®, or any other suitable material. Dry-erase media in the form of thin, flexible sheets are commercially available. See, e.g. the Poly-Rite dry erase roll available from Whiteboards Etc. (Westborough, Mass., Catalogue No. 87500-6).

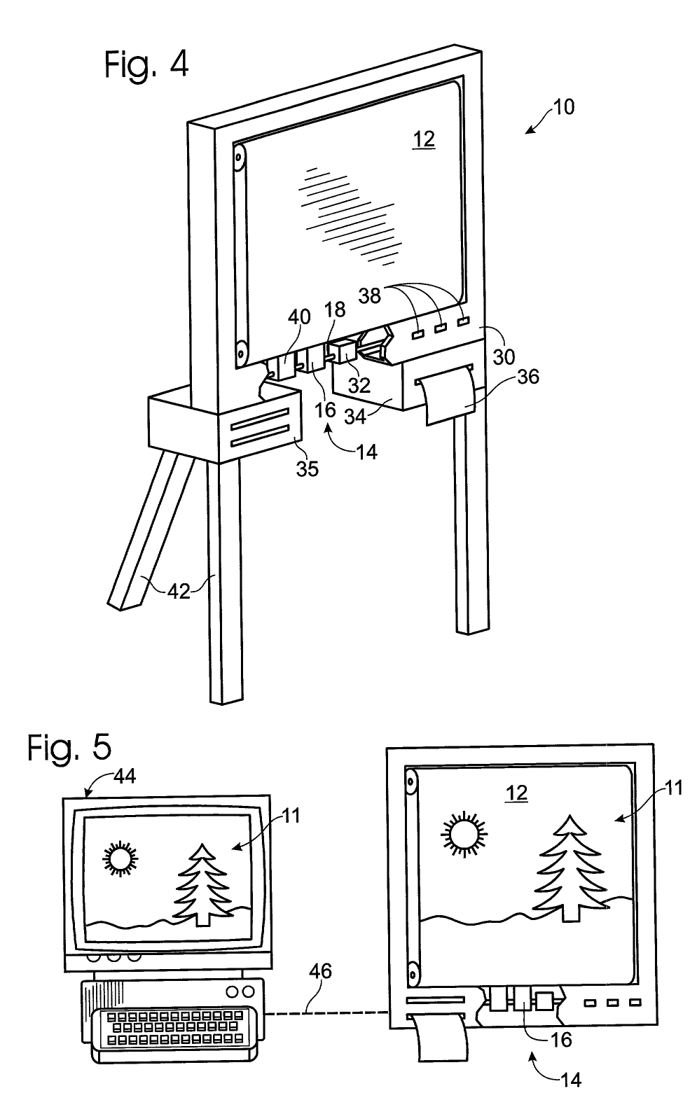

As shown in FIG. 4, presentation system 10 may further include a scanner 32 to scan an image on writing surface 12. The scanned image may be sent to a computer to produce a soft copy and/or the image may be reduced and printed by an attached printer 34 to produce a hard copy. Printer 34 may be configured to print onto media of any conventional size, including, for example, sheet 36. Alternatively, images on writing surface 12 may be scanned, saved into a computer system, and later reproduced on the writing surface or presentation board by the presentation system. Scanner 32 may be configured to scan media other than writing surface 12. For example, scanner 32 may be adapted to scan images on media other than writing surface 12. The scanned images may then be transmitted to printer 14 and printed on writing surface 12. Alternatively, presentation system 10 may include an external scanner 35. As a further alternative, printer 34 may be a combination printer/scanner.

Presentation system 10 may include user input devices 38 to interface with the user. For example, if the printer or presentation system includes its own processor, the presentation system may include user inputs that are pre-programmed to print commonly used images, such as company logos, confidential notices, tables, graphs, etc. Additionally, or alternatively, the presentation system 10 may include user inputs to rotate the writing surface 12, scan the writing surface, and/or print the contents of the writing surface.

The presentation system 10 may include an eraser 40. The eraser may reciprocate on traverse rail 18, as shown in FIG. 4, or may span the length or width of writing surface 12. As with printhead 16, eraser 40 may traverse writing surface 12 in the X and/or Y direction, or the writing surface may move beneath the eraser in the X or Y direction.

FIG. 4 shows a presentation system 10 of the present invention including an outer casing, or frame, 30. The presentation system of the present invention may include an outer casing including a mounting device adapted to enable the presentation system to be mounted to a wall or stand. Alternatively, the presentation system may be integrated within a stand or easel 42.

Presentation system 10 provides the user with flexibility with respect to how images are placed on writing surface 12. The user may hand draw images directly onto the writing surface or print an image stored in electronic form. The electronic image may be created while the presentation system is being used, i.e. the user may create an image on a computer and the image may then be reproduced onto the writing surface by the presentation system. The image may be reproduced onto the writing surface as the image is being created, or after the image has been completed. Alternatively, the image may be obtained from a stored file. The file may contain an image that was previously scanned into and saved on an electronic medium, an image that was created on a computer and saved on an electronic medium, or an electronic image obtained from any other suitable source.

The presentation system 10 may be used as a presentation board. The writing surface of a presentation board is typically large enough to be viewed by several users simultaneously and is often configured to hang or stand vertically such that it can be viewed by several seated users in a classroom, meeting room, or like environment. Currently available commercial presentation boards include chalkboards, white boards, and large pads of paper, typically mounted to a wall or on an easel or other stand. Presentation boards are typically, though not necessarily, larger than 2′×3′ and are often as big as 4′×5′ or larger. The presentation board may include a static writing surface that does not move, as described above with reference to FIG. 1, or a moving writing surface as described above with reference to FIGS. 2-4.

FIG. 5 depicts the presentation system in use. An image 11 is obtained by printer 14, including printhead 16. The image is printed on writing surface 12 by printhead 16. Image 11 may be sent to printer 14 by a computer 44, which is in communication with printer 14 via communication line 46. The method of communication between computer 44 and printer 14 may be any suitable wired or wireless communication.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

We claim:

1. A presentation system comprising:
a writing surface coupled with a frame, the writing surface being adapted to receive erasable ink; and
a printer coupled with the frame, the printer including a printhead configured to print an image on the writing surface with erasable ink.

2. The presentation system of claim 1 wherein the printhead is adapted to move along a traverse rail.

3. The presentation system of claim 2 wherein the traverse rail is adapted to traverse the writing surface.

4. The presentation system of claim 2 wherein the writing surface is adapted to move past the printhead.

5. The presentation system of claim 4 wherein the writing surface is a flexible sheet configured for selected passage past the printhead.

6. The presentation system of claim 4 further comprising a roller mechanism configured to engage the flexible sheet to pass the flexible sheet past the printhead.

7. The presentation system of claim 6 wherein the flexible sheet forms a continuous loop.

8. The presentation system of claim 6 wherein the rollers are motor-driven and adapted to rotate the rollers such that the writing surface is moved past the printhead.

9. The presentation system of claim 1 further including a scanner.

10. The presentation system of claim 9 wherein the scanner is adapted to scan the writing surface.

11. The presentation system of claim 10 including an attached second printer in communication with the scanner.

12. The presentation system of claim 1 further including an eraser adapted to erase the writing surface.

13. The presentation system of claim 12 wherein the eraser is adapted to traverse the writing surface.

14. The presentation system of claim 12 wherein the writing surface is adapted to move past the eraser.

15. The presentation system of claim 1 in combination with a processor having memory, the processor being in communication with the printer and adapted to provide an image to the printer to be printed on the writing surface.

16. The presentation system of claim 1 wherein the erasable ink is dry-erase ink.

17. The presentation system of claim 1 wherein the writing surface is 2′×3′ or larger.

18. A presentation system comprising:
a presentation board adapted to display an image for simultaneous viewing by a plurality of viewers, the presentation board comprising:
a writing surface; and
a printer disposed to print onto the writing surface;
an electronic image; and
a processor adapted to transmit the electronic image to the printer.

19. The presentation system of claim 18 wherein the printhead is adapted to print with erasable ink and the writing surface is adapted to receive erasable ink.

20. The presentation system of claim 19 wherein the erasable ink is dry-erase ink.

21. The presentation system of claim 19 further including a scanner.

22. The presentation system of claim 19 further including an eraser.

23. A method for creating an image to be viewed during a presentation comprising:
obtaining, in electronic form, the image to be viewed;
sending the image to a presentation system including a printer with a printhead adapted to print onto a writing surface; and
printing the image on the writing surface.

24. The method of claim 23 wherein the printer is adapted to print images in dry-erase ink.

25. The method of claim 23 further comprising, scanning an image on the writing surface, saving the scanned image in electronic form, and printing the scanned image on the writing surface at a later time.
